(19) United States
(12) Patent Application Publication
(10) Pub. No.: US 2026/0365227 A1
(43) Pub. Date: Nov. 19, 2026

(54) STEERING COLUMN ASSEMBLY

(71) Applicant: GM Global Technology Operations LLC, Detroit, MI (US)

(72) Inventors: Todd E. Allen, Lake Orion, MI (US); Rajeev Vyas, Rochester Hills, MI (US); Chandra S. Namuduri, Troy, MI (US); Thomas W. Nehl, Shelby Township, MI (US); Peng Peng, Rochester Hills, MI (US)

(21) Appl. No.: 19/207,784

(22) Filed: May 14, 2025

(51) Int. Cl. B62D 5/00; B62D 1/16; H02K 1/17; H02K 7/10; H02K 21/26

(52) U.S. Cl. CPC B62D 5/001; B62D 1/16; H02K 1/17; H02K 7/10; H02K 21/26

(57) ABSTRACT

A steering column assembly for a steer by wire steering system of a vehicle includes a steering shaft rotationally supported within the steering column assembly and adapted to support a steering wheel at a distal end thereof, and a homopolar direct drive unit adapted to selectively apply rotational torque to the steering shaft, the homopolar direct drive unit including a non-ferrous stator assembly fixedly mounted to the steering column assembly; and a ferrous rotor fixedly mounted to the steering shaft for rotation therewith and in operational engagement with the stator.

### INTRODUCTION

The present disclosure relates to a steering column assembly for a steer by wire system for a vehicle. Steer by wire consists of a steering column assembly, and a steering rack actuator wherein there is no mechanical connection between the steering column assembly and the steering rack actuator. Rather, signals from the steering column assembly are electronically communicated to the steering rack actuator. The steering column assembly generates force feedback for a driver of the vehicle to simulate steering feel and communicates the driver's steering input “by-wire” quickly and precisely to the steering rack actuator, which steers the wheels, depending on the driving speed and conditions.

While current steering column assemblies for steer by wire systems achieve their intended purpose, there is a need for a new and improved system that utilizes both a homopolar direct drive unit to provide rotational torque input to a steering shaft of the steering column assembly and a magneto-rheological brake to provide resistance to rotational movement of the steering shaft of the steering column assembly to provide force feedback to the steering shaft and a steering wheel mounted thereon and simulating steering feel for a driver of the vehicle.

### SUMMARY

According to several aspects of the present disclosure, a steering column assembly for a steer by wire steering system of a vehicle includes a steering shaft rotationally supported within the steering column assembly and adapted to support a steering wheel at a distal end thereof, and a homopolar direct drive unit adapted to selectively apply rotational torque to the steering shaft, the homopolar direct drive unit including a non-ferrous stator assembly fixedly mounted to the steering column assembly, a ferrous rotor interconnected to the steering shaft and in operational engagement with the stator assembly, wherein rotational motion of the rotor is transferred to the steering shaft.

According to another aspect, the stator assembly includes a plurality of stator winding nodes supported on a first axial surface of the stator assembly in a circular pattern.

According to another aspect, each one of the plurality of stator winding nodes includes a core defining an upper channel and a lower channel, a rare earth magnet positioned within the upper channel and a rare earth magnet positioned within the lower channel, and a copper winding wrapped around the core and the rare earth magnets, the copper winding including a first end and a second end, wherein, the plurality of stator winding nodes are connected to one another in series, via the first and second ends of the copper windings, around the stator assembly.

According to another aspect, for each one of the plurality of stator winding nodes, a gap is present adjacent each side of the rare earth magnet positioned within the upper channel and a gap is present adjacent each side of the rare earth magnet positioned within the lower channel.

According to another aspect, the stator assembly includes a plurality of fir-tree columns extending axially from the first axial surface of the stator assembly, one fir-tree column positioned between each adjacent pair of the plurality of stator winding nodes, the fir-tree columns adapted to support the plurality of stator winding nodes on the stator assembly.

According to another aspect, the core of each of the plurality of stator winding nodes includes a first side having an axial notch and a second side having an axial notch, each of the plurality of fir-tree columns includes an axial ridge extending along a first side and an axial ridge extending along a second side, wherein, for each one of the plurality of stator winding nodes the first side of the core is positioned in contact with the second side of a one of the plurality of fir-tree columns that is adjacent the first side of the core, and the axial ridge of the second side of the one of the plurality of fir-tree columns that is adjacent the first side of the core engages the axial notch of the first side of the core, and the second side of the core is positioned in contact with the first side of a one of the plurality of fir-tree columns that is adjacent the second side of the core, and the axial ridge of the first side of the one of the plurality of fir-tree columns that is adjacent the second side of the core engages the axial notch of the second side of the core.

According to another aspect, the core of each of the plurality of stator winding nodes includes a first retaining finger adjacent the first side and extending axially through a hole formed within the stator assembly, and a second retaining finger adjacent the second side and extending axially through a hole formed within the stator assembly, the steering column assembly including a plurality of retaining clips, each retaining clip adapted to secure a distal end of the first retaining finger of one of the plurality of stator winding nodes to a distal end of the second retaining finger of an adjacent one of the plurality of stator winding nodes adjacent a second axial surface of the stator assembly and prevent any of the plurality of stator winding nodes from being removed from the first surface of the stator assembly.

According to another aspect, for each of the plurality of stator winding nodes, the first retaining finger includes a channel adapted to partially surround the first end of the copper winding, wherein the first end of the copper winding extends through the hole in the stator assembly along with the first retaining finger, and the second retaining finger includes a channel adapted to partially surround the second end of the copper winding, wherein the second end of the copper winding extends through the hole in the stator assembly along with the second retaining finger.

According to another aspect, the stator assembly and the steering shaft are supported relative to one another by a roller bearing adapted to allow the steering shaft to rotate relative to the stator assembly, the steering column assembly further including a magnetorheological brake adapted to selectively provide resistance to rotational movement of the steering shaft.

According to another aspect, the magnetorheological brake includes an outer shell fixedly mounted onto a radially inner surface of the stator assembly, an electromagnetic coil extending around the outer shell between the outer shell and the stator assembly, a drum fixedly mounted onto the steering shaft and rotatable with the steering shaft, a pair or roller bearings adapted to support the outer shell and the drum relative to one another and allow rotational movement of the drum within the outer shell, and a magnetorheological fluid positioned within a chamber defined by the outer shell and the drum, wherein selective activation of the electromagnetic coil creates an electromagnetic field to the chamber and changes viscosity of the magnetorheological fluid therein.

According to another aspect, the stator assembly and the rotor are supported relative to one another by a roller bearing adapted to allow the rotor to rotate relative to the stator assembly, the steering column assembly further including a planetary gearset positioned between and interconnecting the rotor to the steering shaft and adapted to increase the torque transferred from the rotor to the steering shaft.

According to several aspects of the present disclosure, a steer by wire steering system for a vehicle includes a controller, a road wheel actuator in communication with the controller and adapted to control steerable wheels of the vehicle, and a steering column assembly, the steering column assembly including a steering shaft rotationally supported within the steering column assembly and adapted to support a steering wheel at a distal end thereof, and a homopolar direct drive unit adapted to selectively apply rotational torque to the steering shaft, the homopolar direct drive unit including a non-ferrous stator assembly fixedly mounted to the steering column assembly and including a plurality of stator winding nodes supported on a first axial surface of the stator assembly in a circular pattern, a ferrous rotor interconnected to the steering shaft and in operational engagement with the stator assembly, wherein rotational motion of the rotor is transferred to the steering shaft.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including a steering system according to an exemplary embodiment of the present disclosure;

FIG. 2 is a schematic diagram of the steering system;

FIG. 3 is a side sectional view of a steering column assembly in accordance with an exemplary embodiment of the present disclosure;

FIG. 4 is a side sectional view of a steering column assembly without a magnetorheological brake;

FIG. 5 is a front view of a first axial surface of a stator assembly of the present disclosure;

FIG. 6 is an enlarged view of FIG. 5, as indicated by the portion of FIG. 5 circled and labelled “FIG. 6”;

FIG. 7 is a perspective view of a stator winding node in accordance with an exemplary embodiment of the present disclosure;

FIG. 8 is a sectional view taken along the line labelled “FIG. 8-FIG. 8” in FIG. 7;

FIG. 9 is a schematic sectional view taken along the line labelled “FIG. 9-FIG. 9” in FIG. 4;

FIG. 10 is a perspective view of a second axial surface of the stator assembly wherein retaining fingers of the stator winding nodes extend through holes in the stator assembly and extend axially from the second axial surface;

FIG. 11 is a rear view of the second axial surface of the stator assembly illustrating two alternate current flow paths around the plurality of series connected stator winding nodes;

FIG. 12 is an exploded view illustrating how a stator winding node engages the first axial surface of the stator assembly when placed thereon;

FIG. 13 is and enlarged view of the portion of FIG. 3 labelled “FIG. 13” in FIG. 3;

FIG. 14 is a side sectional view of an exemplary embodiment of the steering column assembly, including a planetary gearset interconnecting the rotor to the steering shaft; and

FIG. 15 is a perspective view of the planetary gearset shown in FIG. 14.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges. In addition, disclosure of ranges includes disclosure of all values and further divided ranges within the entire range, including endpoints and sub-ranges given for the ranges.

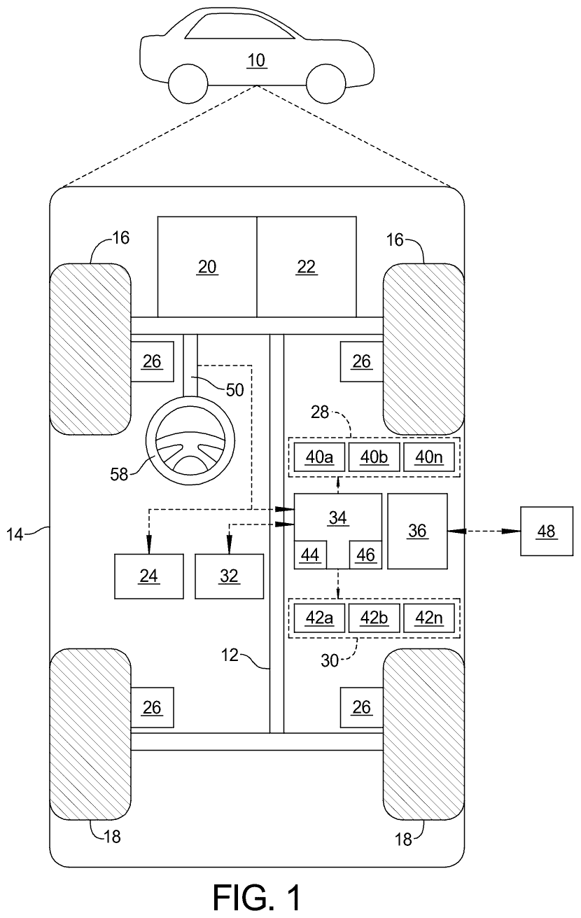

Example embodiments will now be described more fully with reference to the accompanying drawings. In accordance with an exemplary embodiment, FIG. 1 shows a vehicle 10 with an associated steer-by-wire system 24 including a steering column assembly 50 in accordance with embodiments of the present disclosure. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle or partially autonomous vehicle. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four automation system. A Level Four system indicates “high automation”, referring to the driving mode-specific performance by an automated driving system of all aspects of the dynamic driving task, even if a human user does not respond appropriately to a request to intervene. A level four autonomous vehicle may be operated in a manual mode, wherein a driver within the vehicle 10 operates the vehicle 10 just as in a non-autonomous vehicle, and in an autonomous mode, wherein certain or all aspects of driving control are automated. The novel aspects of the present disclosure are also applicable to non-autonomous vehicles.

As shown, the vehicle 10 generally includes a propulsion system 20, a transmission system 22, a steer-by-wire system 24, a brake system 26, a sensor system 28, an actuator system 30, at least one data storage device 32, a vehicle controller 34, and a wireless communication module 36. In an embodiment in which the vehicle 10 is an electric vehicle, there may be no transmission system 22. The propulsion system 20 may, in various embodiments, include an internal combustion engine, an electric machine such as a traction motor, and/or a fuel cell propulsion system. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image or map. The plurality of sensing devices 40a-40n is used to determine information about an environment surrounding the vehicle 10. In an exemplary embodiment, the plurality of sensing devices 40a-40n includes at least one of a motor speed sensor, a motor torque sensor, an electric drive motor voltage and/or current sensor, an accelerator pedal position sensor, brake pedal position sensor, a coolant temperature sensor, a cooling fan speed sensor, and a transmission oil temperature sensor.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

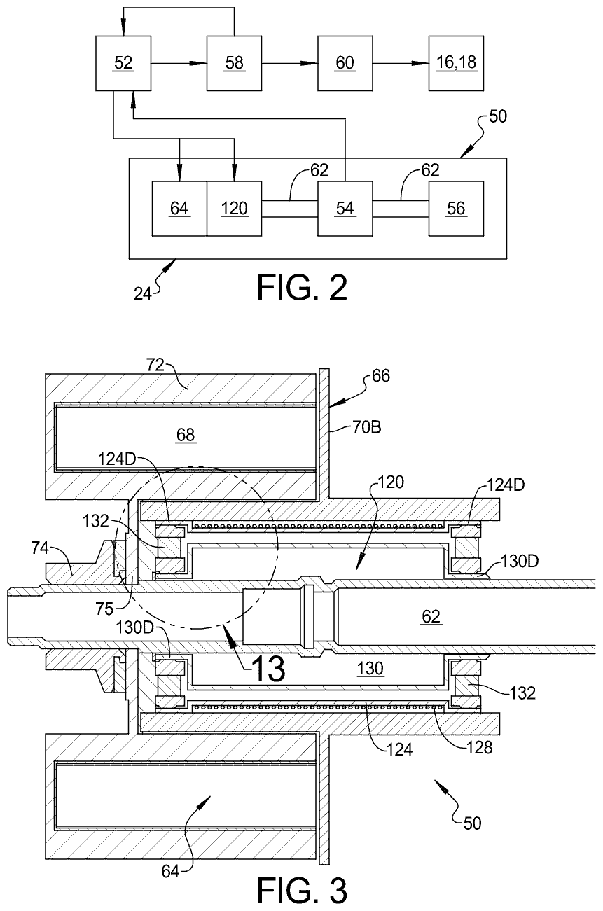

Referring to FIG. 1 and FIG. 2, the steer-by-wire system 24 influences a position of the front wheels 16 and rear wheels 18. In an exemplary embodiment, the steering system 24 includes a steering column assembly 50 and a system controller 52. The system controller 52 is in communication with a steering wheel actuator 54. The system controller 52 may be the vehicle controller 34 or may be a separate controller 52 in communication with the vehicle controller 34 and various other systems and sub-systems within the vehicle 10.

The steering wheel actuator 54 is adapted to collect data related to a state of a steering wheel 56 such as the steering wheel angle, torque applied to the steering wheel and velocity of rotation of the steering wheel, and communicate the data to the system controller 52. The plurality of sensors 40a-40n include sensors adapted to measure the steering wheel angle, torque applied to the steering wheel and velocity of rotation of the steering wheel 56, and communicate this data to the steering wheel actuator 54.

A road wheel actuator 58 is in communication with the system controller 52 and is adapted to collect data related to a state of the road wheel actuator 58, such as position of a steering rack 60 and estimated torque acting on the steering rack 60, and communicate the data to the system controller 52, and control the steering rack 60 and steering of the vehicle 10 based on instructions received from the system controller 52. The system controller 52 uses algorithms stored therein to provide control instructions to the road wheel actuator 58 to control the steering rack 60 under all anticipated operating conditions and providing all options.

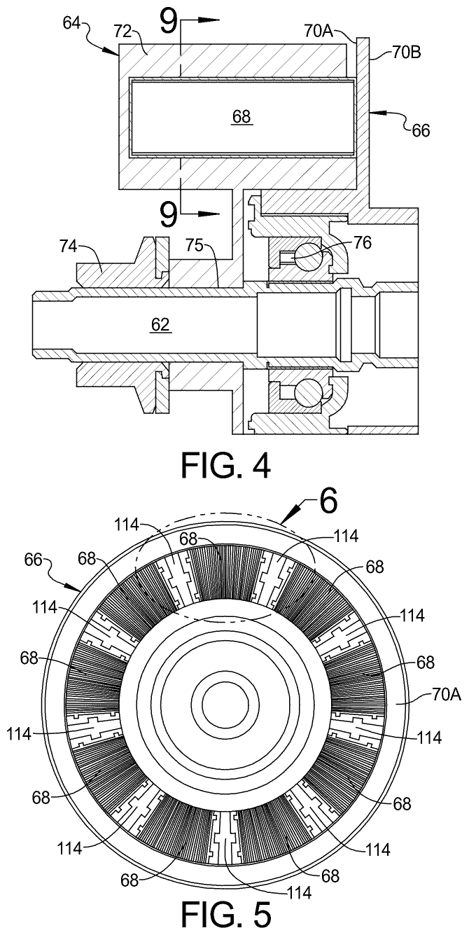

Referring to FIG. 2, FIG. 3 and FIG. 4, in an exemplary embodiment, the steering column assembly 50 includes a steering shaft 62 rotationally supported within the steering column assembly 50 and adapted to support the steering wheel 56 at a distal end thereof. A homopolar direct drive unit 64 is adapted to selectively apply rotational torque to the steering shaft 62. A homopolar motor is a direct current electric motor with two magnetic poles, the conductors of which always cut unidirectional lines of magnetic flux by rotating a conductor around a fixed axis so that the conductor is at right angles to a static magnetic field. As the name “homopolar” indicates, the electrical polarity of the conductor and the magnetic field poles do not change (i.e., it does not require commutation).

In an exemplary embodiment, the homopolar direct drive unit 64 includes a non-ferrous stator assembly 66 fixedly mounted to the steering column assembly 50. The steering column assembly 50 is fixedly mounted within the vehicle 10, such that the steering column assembly 50 and any component fixedly mounted to the steering column assembly 50 do not rotate. The stator assembly 66 includes a plurality of stator winding nodes 68 supported on a first axial surface 70 of the stator assembly 66 in a circular pattern. A ferrous rotor 72 is fixedly mounted to the steering shaft 62 for rotation therewith and in operational engagement with the stator assembly 66. The homopolar direct drive unit 64 uses force applied to a ferrous object (rotor 72) moving through a magnetic field to simulate torque. Force direction, and direction of rotation of the rotor 72, and thus the rotational direction of the steering shaft 62, is based on Flemming's left hand rule.

As shown, the rotor 72 is fixedly mounted directly to the steering shaft 62, and secured thereon by a fastener 74, such as a nut or the like. The engagement between the rotor 72 and the steering shaft 62, as indicted at 75, may included a splined or interference fit arrangement, further ensuring rotational movement of the rotor 72 and the steering shaft 62 unitarily. The stator assembly 66 is supported on the steering shaft 62 by a roller bearing 76. The roller bearing 76 provides support and maintains relative position of the stator assembly relative to the steering shaft 62 and allows the steering shaft 62 to rotate (along with the rotor 72) relative to the stator assembly 66.

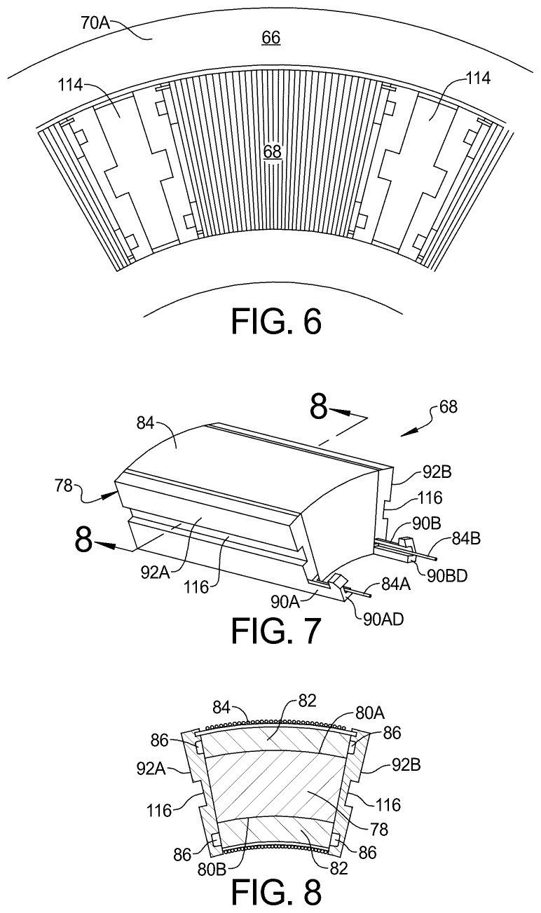

Referring to FIG. 5 and FIG. 6, in an exemplary embodiment, the stator assembly 66, shown with the rotor 72 removed, includes a plurality of stator winding nodes 68 supported on the first axial surface 70 of the stator assembly 66 in a circular pattern. Multiple winding nodes 68 are supported on the stator assembly 66 and connected in series to maximize the force and torque generated by the homopolar direct drive unit 64. As shown, the homopolar direct drive unit 64 includes nine winding nodes 68 spaced thereabout and connected in series.

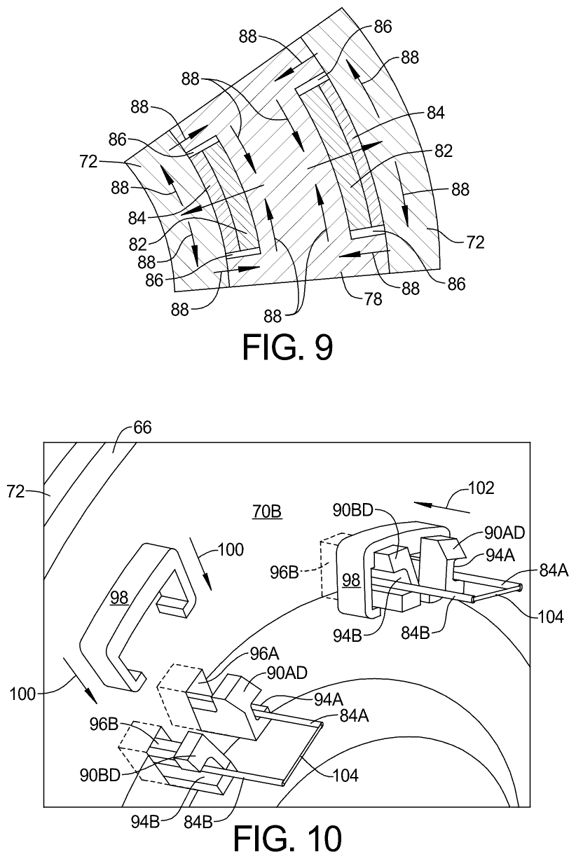

Referring to FIG. 7 and FIG. 8, each one of the plurality of stator winding nodes 68 includes a core 78 made from a ferrous material, such as iron, and defining an upper channel 80A and a lower channel 80B. A rare earth magnet 82 is placed within each of the upper channel 80A and the lower channel 80B, and a copper winding 84 is wrapped around the core 78 and the rare earth magnets 82. The copper winding 84 includes a first end 84A and a second end 84B. In an exemplary embodiment, for each one of the plurality of winding nodes 68, a gap 86 is present adjacent each side of the rare earth magnet 82 positioned within the upper channel 80A and a gap 86 is present adjacent each side of the rare earth magnet 82 positioned within the lower channel 80B. Referring to FIG. 9, the gaps 86 ensure that magnetic flux is directed outward through the ferrous rotor 72 and back through the stator core 78 as indicated by arrows 88.

Referring again to FIG. 7, the core 78 of each one of the plurality of stator winding nodes 68 includes a first retaining finger 90A adjacent a first side 92A and includes a channel 94A adapted to partially surround the first end 84A of the copper winding 84, wherein the first end 84A of the copper winding 84 extends axially from the core 78 within the channel 94A. The core 78 of each one of the plurality of stator winding nodes 68 further a second retaining finger 90B adjacent a second side 92B and includes a channel 94B adapted to partially surround the second end 84B of the copper winding 84, wherein the second end 84A of the copper winding 84 extends axially from the core 78 within the channel 94B.

Referring to FIG. 10, the first end 84A of the copper winding 84, along with the first retaining finger 90A extends through a first hole 96A formed within the stator assembly 66, wherein the first end 84A of the copper winding 84 and a distal end 90AD of the first retaining finger 90A extend through the first hole 96A and extend axially from a second axial surface 70B of the stator assembly 66. The second end 84B of the copper winding 84, along with the second retaining finger 90B extends through a second hole 96B formed within the stator assembly 66, wherein the second end 84B of the copper winding 84 and a distal end 90BD of the second retaining finger 90B extend through the first hole 96B and extend axially from the second axial surface 70B of the stator assembly 66.

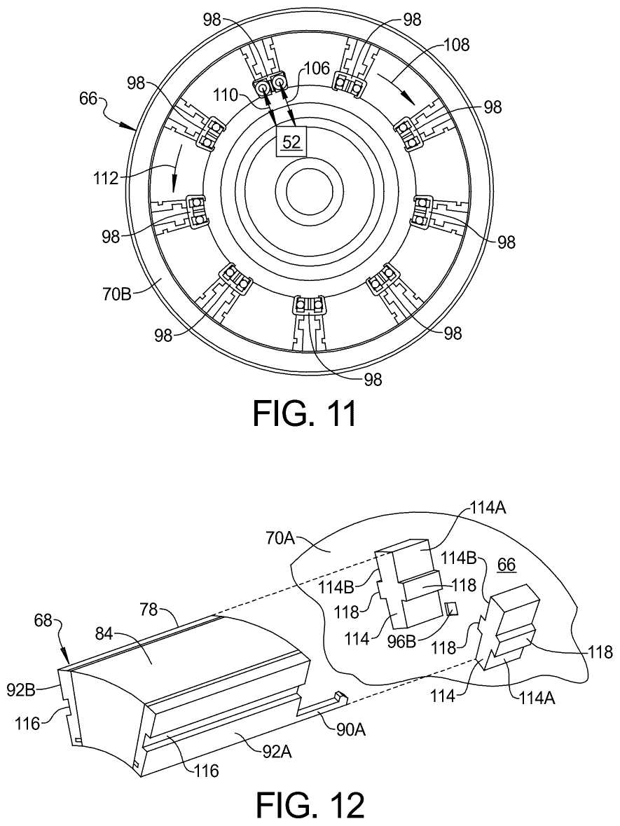

The first hole 96A and the second hole 96B, while distinguished from one another for purposes of this description, are identical. The stator assembly 66 includes a plurality of identical holes, a first hole 96A and a second hole 96B for each of the plurality of stator winding nodes 68. Referring again to FIG. 10 and to FIG. 11, In an exemplary embodiment, the steering column assembly 50 includes a plurality of retaining clips 98. Each retaining clip 98 is adapted to be placed, as indicated by arrows 100, onto a distal end 90AD of the first retaining finger 90A of one of the plurality of stator winding nodes 68 and to a distal end 90BD of the second retaining finger 90B of an adjacent one of the plurality of stator winding nodes 68, adjacent the second axial surface 70B of the stator assembly 66. Once placed thereon, each retaining clip 98 is adapted to prevent any of the plurality of stator winding nodes 68 from being pulled, axially, as indicated by arrow 102, and removed from the first axial surface 70A of the stator assembly 66, by providing a positive stop against the second axial surface 70B of the stator assembly 66.

The copper windings 84 of the plurality of stator winding nodes 68 are connected in series, wherein a first end 84A of the copper winding 84 of each stator winding node 68 is connected, as indicated at 104 in FIG. 10, to a second end 84B of the copper winding 84 of an adjacent one of the plurality of stator winding nodes 68. The first and second ends 84A, 84B of the copper windings 84 of the stator winding nodes 68 may be connected by any suitable means, including soldering, twisting, or using a connector. In an exemplary embodiment, each retaining clip 98 includes features that provide a conductive connection between the first and second ends 84A, 84B of copper windings 84 when the retaining clip is placed onto the distal ends 90AD, 90BD of the first and second retaining fingers 90A, 90B of adjacent stator winding nodes 68.

As in to be understood by those skilled in the art, current applied from the system controller 52 to the series connected copper windings 84, as indicated by arrow 106 in FIG. 11, results in the current travelling, in a clockwise direction, from stator winding node 68 to stator winding node 68, around the stator assembly 66, as indicated by arrow 108, resulting in torque applied to the rotor 72, and consequently to the steering shaft 62, in a first direction. Alternatively, current applied from the system controller 52 to the series connected copper windings 84, as indicated by arrow 110 in FIG. 11, results in the current travelling, in a counter-clockwise direction, from stator winding node 68 to stator winding node 68, around the stator assembly 66, as indicated by arrow 112, resulting in torque applied to the rotor 72, and consequently to the steering shaft 62, in a second direction. Thus, the system controller 52 can provide directional torque feedback to the steering wheel 56 by providing current to the stator assembly 66, wherein the direction of the current controls the direction of the torque feedback at the steering wheel 56 and the magnitude of the current controls the amount of feedback force provided.

Drivers use torque feedback at the steering wheel 56 to obtain information about the road and tire dynamics. This aids a driver in driving tasks like curve negotiation. Steer-by-wire vehicles, due to the mechanical decoupling of the front tires and steering wheel 56, do not have any inherent steering feedback and require an artificial steering feel. The homopolar direct drive unit 64 of the present disclosure provides such active torque feedback at the steering wheel 56.

Referring again to FIG. 5 and FIG. 6, in an exemplary embodiment the stator assembly 66 includes a plurality of fir-tree columns 114 integrally formed with and extending axially from the first axial surface 70A of the stator assembly 66. One fir-tree column 114 is positioned between each adjacent pair of the plurality of stator winding nodes 68. Two adjacent fir-tree columns 114 support a single stator winding node 68 therebetween, and, collectively, the plurality of fir-tree columns 114 is adapted to support the plurality of stator winding nodes 68 on the stator assembly 66.

The plurality of fir-tree columns 114 engage the plurality of stator winding nodes 68 to provide axial, radial and angular positioning of the plurality of stator winding nodes 68 on the first axial surface 70A of the stator assembly 66, and, provide proper circumferential spacing of the plurality of stator winding nodes 68 relative to one another.

Referring again to FIG. 6 and FIG. 7, the core 78 of each of the plurality of stator winding nodes 68 includes an axial notch 116 formed within the first side 92A and an axial notch 116 formed within the second side 92B, and, each of the plurality of fir-tree columns 114 includes an axial ridge 118 extending along a first side 114A and an axial ridge 118 extending along a second side 114B. Referring again to FIG. 6, and to FIG. 12, for each one of the plurality of stator winding nodes 68, the first side 92A of the core 78 is positioned in contact with the second side 114B of a one of the plurality of fir-tree columns 114 that is adjacent the first side 92A of the core 78, and the axial ridge 118 of the second side 114B of the one of the plurality of fir-tree columns 114 that is adjacent the first side 92A of the core 78 engages the axial notch 116 of the first side 92A of the core 78, the second side 92B of the core 78 is positioned in contact with the first side 114A of a one of the plurality of fir-tree columns 114 that is adjacent the second side 92B of the core 78, and the axial ridge 118 of the first side 114A of the one of the plurality of fir-tree columns 114 that is adjacent the second side 92B of the core 78 engages the axial notch 116 of the second side 92B of the core 78. It should be understood by those skilled in the art that the axial notches 116 formed within the first and second sides 92A, 92B of each of the plurality of stator winding nodes 68 are identical, and, each of the axial ridges 118 of the first and second sides 114A, 114B of each of the plurality of fir-tree columns 114 are identical.

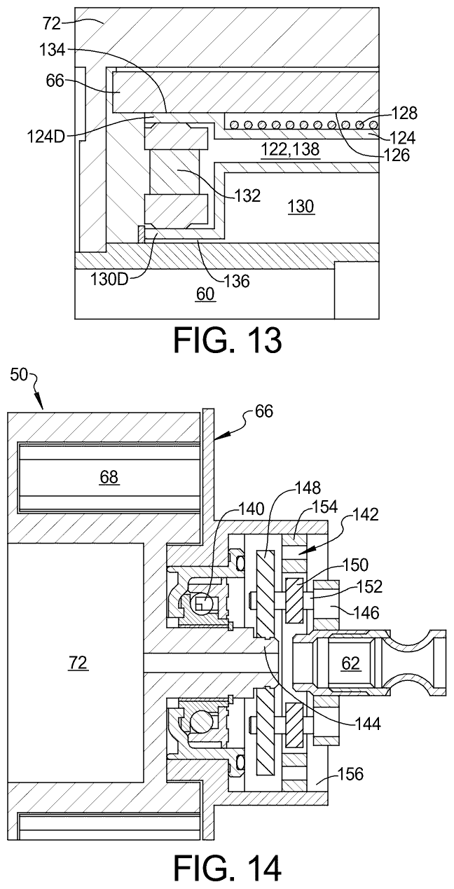

Referring again to FIG. 3, and to FIG. 13, in an exemplary embodiment, the steering column assembly 50 further includes a magnetorheological brake 120 adapted to selectively provide resistance to rotational movement of the steering shaft 62. A magnetorheological brake (MR brake) 120 selectively, upon actuation by the system controller 52, applies an electrical field to magnetorheological fluid (MR fluid) 122 to increase frictional characteristics of the MR fluid 122 to make rotation of the steering shaft 62 easier or harder.

In an exemplary embodiment, the MR brake 120 includes an outer shell 124 fixedly mounted onto a radially inner surface 126 defined by the stator assembly 66. An electromagnetic coil 128 extends around the outer shell 124, radially between the outer shell 124 and the stator assembly 66 and axially between distal ends 124D of the outer shell 124 that are attached to the radial inner surface 126 of the stator assembly 66. A drum 130 is fixedly mounted onto the steering shaft 62 and is rotatable with the steering shaft 62. A pair of roller bearings 132 are adapted to support the outer shell 124 and stator assembly 66 on distal ends 130D of the drum 130 that are affixed to the steering shaft 62, thus supporting the steering shaft 62 and the drum 130 within the outer shell 124 and the stator assembly 66 while allowing rotational movement of the steering shaft 62 and the drum 130 relative to the outer shell 124 and the stator assembly 66.

The engagement between the distal ends 124D of the outer shell 124 and the inner surface 126 of the stator assembly 66, as indicted at 134, may include a splined or interference fit arrangement, further ensuring fixed attachment of the outer shell 124 to the stator assembly 66, and the engagement between the distal ends 130D of the drum 130 and the steering shaft 62, as indicted at 136, may include a splined or interference fit arrangement, further ensuring rotational movement of the drum 130 and the steering shaft 62 unitarily.

The drum 130 and the outer shell 124 define a chamber 138 therebetween and the MR fluid 122 is positioned therein, such that, upon selective activation of the electromagnetic coil 128 an electromagnetic field is applied to the MR fluid 122, changing the viscosity of the MR fluid 122. The higher the amount of electromagnetic field, the more the viscosity of the MR fluid changes. Thus, the system controller 52 can control the selective actuation of the electromagnetic coil 128 to selectively actuate the MR brake 120 and to selectively tune the MR brake 120 to apply more or less resistance to rotation of the steering shaft 62.

The homopolar direct drive unit 64 provides active feedback to an operator of the vehicle 10 by applying rotational torque directly, in one direction or the other, to the steering wheel 56 of the vehicle 10. The MR brake provides passive feedback by way of increased resistance and dampening of rotation of the steering wheel 56. The homopolar direct drive unit 64 and the MR brake 120 may be actuated individually by the system controller 52, or, may be actuated in unison to provide high levels of torque resistance to rotational motion of the steering shaft 62 when necessary. The system controller 52, using algorithms stored therein, manages the direction and magnitude of the current passed through the series connected stator winding nodes 68 of the homopolar direct drive unit 64 and the magnitude of the current applied, via the electromagnetic coil 128, to the MR fluid 122 of the MR brake 120 based on driver input and signals from the road wheel actuator 58. The steering column assembly 50 of the present disclosure may comprise an existing steering column that is retro-fitted with a module including the homopolar direct drive unit 64 and the MR brake 120.

Referring to FIG. 14, in another exemplary embodiment, the stator assembly 66 and the rotor 72 are supported relative to one another by a roller bearing 140 adapted to allow the rotor 72 to rotate relative to the stator assembly 66, and, rather than including an MR brake 120, a planetary gearset 142 is positioned between and interconnects the rotor 72 to the steering shaft 62. The planetary gearset 142 transfers rotational motion of the rotor 72 to the steering shaft 62 and acts as a torque multiplier, increasing the torque transferred from the rotor 72 to the steering shaft 62.

The homopolar direct drive unit 64 provides active feedback to an operator of the vehicle 10 by applying rotational torque directly, in one direction or the other, to the steering shaft 62 and the steering wheel 56 of the vehicle 10. The planetary gearset 142 passively increases the amount of torque applied to the steering shaft 62 from the rotor 72, thus increasing the total amount of feedback torque able to be applied to the steering shaft 62 and steering wheel 56, and thus experienced by the operator of the vehicle 10. An advantage of the planetary gearset 142 over the MR brake 120 is that the planetary gearset 142 provides increased torque capability to active feedback imparted by the rotor 72 of the homopolar direct drive unit 64, while the MR brake 120 simply increases resistance to rotation of the steering shaft 62.

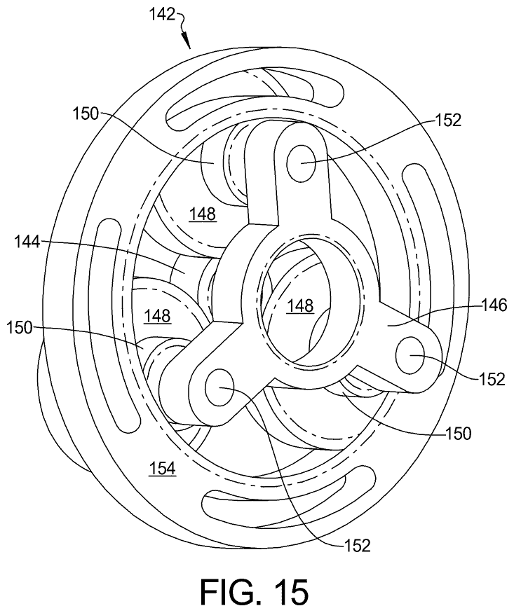

Referring again to FIG. 14 and to FIG. 15, in an exemplary embodiment, a portion of the rotor 72 defines a sun gear 144 of the planetary gearset 142. A carrier 146 rotatably supports a plurality of first pinion gears 148 and a corresponding plurality of second pinion gears 150. Each first pinion gear 148 is fixedly mounted onto a pin 152 along with one second pinion gear 150 fixedly mounted onto the pin 152. Each pin 152 is rotatably supported on the carrier 146, wherein the plurality of first pinion gears 148 and the plurality of second pinion gears 150 are rotatable, unitarily relative to the carrier 146. As shown, the planetary gearset 142 includes three first pinion gears 148, three second pinion gears 150 and three pins 152, wherein each pin 152 supports one first pinion gear 148 and one second pinion gear 150.

Each of the plurality of first pinion gears 148 are engaged with the sun gear 144, and each of the plurality of second pinion gears 150 are engaged with a ring gear 154 fixedly attached to an inner radial surface 156 of the stator assembly 66. The carrier 146 is fixedly attached to the steering shaft 62, wherein rotational motion of the carrier 146 is transferred to the steering shaft 62. The carrier 146 may be fixedly engaged with the steering shaft 62, and the ring gear 154 may be fixedly attached to the inner radial surface 156 of the stator assembly 66 by any suitable methods, including, but not limited to, a splined engagement, a slotted engagement, a bolt or pin extending therethrough, or press-fit. It should be understood that other methods of engagement can be utilized without departing from the novel features of the present disclosure.

As the rotor 72, and thus, the sun gear 144, rotates, engagement between the sun gear 144 and the plurality of first pinion gears 148 causes the first pinion gears 148 to rotate. Rotation of the plurality of first pinion gears 148 causes corresponding rotation of each of the pins 152 and the plurality of second pinon gears 150. Due to the engagement between the plurality of second pinion gears 150 and the ring gear 154, rotation of the plurality of second pinion gears 150 causes the second pinion gears 150 to “walk” around the ring gear 154, and thus rotates the carrier 146, and steering shaft 62.

Because the plurality of first pinion gears 148 are larger (have more gear teeth) than the plurality of second pinion gears 150, the planetary gearset 142 is a compound planetary gearset, wherein a gear ratio between the rotor 72 and the steering shaft 62 is dependent upon the relative sizes of the first and second pinion gears 148, 150. The amount of torque multiplication applied by the planetary gearset 142 can be customized for a specific application based on relative gear ratios between the first and second pinion gears 148, 150.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A steering column assembly for a steer by wire steering system of a vehicle, comprising:
a steering shaft rotationally supported within the steering column assembly and adapted to support a steering wheel at a distal end thereof; and
a homopolar direct drive unit adapted to selectively apply rotational torque to the steering shaft, the homopolar direct drive unit including:
a non-ferrous stator assembly fixedly mounted to the steering column assembly;
a ferrous rotor interconnected to the steering shaft and in operational engagement with the stator assembly, wherein rotational motion of the rotor is transferred to the steering shaft.

2. The steering column assembly of claim 1, wherein the stator assembly includes a plurality of stator winding nodes supported on a first axial surface of the stator assembly in a circular pattern.

3. The steering column assembly of claim 2, wherein each one of the plurality of stator winding nodes includes:
a core defining an upper channel and a lower channel;
a rare earth magnet positioned within the upper channel and a rare earth magnet positioned within the lower channel; and
a copper winding wrapped around the core and the rare earth magnets, the copper winding including a first end and a second end;
wherein, the plurality of stator winding nodes are connected to one another in series, via the first and second ends of the copper windings, around the stator assembly.

4. The steering column assembly of claim 3, wherein, for each one of the plurality of stator winding nodes, a gap is present adjacent each side of the rare earth magnet positioned within the upper channel and a gap is present adjacent each side of the rare earth magnet positioned within the lower channel.

5. The steering column assembly of claim 4, wherein the stator assembly includes a plurality of fir-tree columns extending axially from the first axial surface of the stator assembly, one fir-tree column positioned between each adjacent pair of the plurality of stator winding nodes, the fir-tree columns adapted to support the plurality of stator winding nodes on the stator assembly.

6. The steering column assembly of claim 5, wherein:
the core of each of the plurality of stator winding nodes includes a first side having an axial notch and a second side having an axial notch;
each of the plurality of fir-tree columns includes an axial ridge extending along a first side and an axial ridge extending along a second side;
wherein, for each one of the plurality of stator winding nodes:
the first side of the core is positioned in contact with the second side of a one of the plurality of fir-tree columns that is adjacent the first side of the core, and the axial ridge of the second side of the one of the plurality of fir-tree columns that is adjacent the first side of the core engages the axial notch of the first side of the core; and
the second side of the core is positioned in contact with the first side of a one of the plurality of fir-tree columns that is adjacent the second side of the core, and the axial ridge of the first side of the one of the plurality of fir-tree columns that is adjacent the second side of the core engages the axial notch of the second side of the core.

7. The steering column assembly of claim 6, wherein:
the core of each of the plurality of stator winding nodes includes:
a first retaining finger adjacent the first side and extending axially through a hole formed within the stator assembly; and
a second retaining finger adjacent the second side and extending axially through a hole formed within the stator assembly;
the steering column assembly including a plurality of retaining clips, each retaining clip adapted to secure a distal end of the first retaining finger of one of the plurality of stator winding nodes to a distal end of the second retaining finger of an adjacent one of the plurality of stator winding nodes adjacent a second axial surface of the stator assembly and prevent any of the plurality of stator winding nodes from being removed from the first surface of the stator assembly.

8. The steering column assembly of claim 7, wherein, for each of the plurality of stator winding nodes:
the first retaining finger includes a channel adapted to partially surround the first end of the copper winding, wherein the first end of the copper winding extends through the hole in the stator assembly along with the first retaining finger; and
the second retaining finger includes a channel adapted to partially surround the second end of the copper winding, wherein the second end of the copper winding extends through the hole in the stator assembly along with the second retaining finger.

9. The steering column assembly of claim 8, wherein the stator assembly and the steering shaft are supported relative to one another by a roller bearing adapted to allow the steering shaft to rotate relative to the stator assembly, the steering column assembly further including a magnetorheological brake adapted to selectively provide resistance to rotational movement of the steering shaft.

10. The steering column assembly of claim 9, wherein the magnetorheological brake includes:
an outer shell fixedly mounted onto a radially inner surface of the stator assembly;
an electromagnetic coil extending around the outer shell between the outer shell and the stator assembly;
a drum fixedly mounted onto the steering shaft and rotatable with the steering shaft;
a pair or roller bearings adapted to support the outer shell and the drum relative to one another and allow rotational movement of the drum within the outer shell; and
a magnetorheological fluid positioned within a chamber defined by the outer shell and the drum, wherein selective activation of the electromagnetic coil creates an electromagnetic field to the chamber and changes viscosity of the magnetorheological fluid therein.

11. The steering column assembly of claim 8, wherein the stator assembly and the rotor are supported relative to one another by a roller bearing adapted to allow the rotor to rotate relative to the stator assembly, the steering column assembly further including a planetary gearset positioned between and interconnecting the rotor to the steering shaft and adapted to increase the torque transferred from the rotor to the steering shaft.

12. A steer by wire steering system for a vehicle, comprising:
a controller;
a road wheel actuator in communication with the controller and adapted to control steerable wheels of the vehicle; and
a steering column assembly, the steering column assembly including:
a steering shaft rotationally supported within the steering column assembly and adapted to support a steering wheel at a distal end thereof; and
a homopolar direct drive unit adapted to selectively apply rotational torque to the steering shaft, the homopolar direct drive unit including:
a non-ferrous stator assembly fixedly mounted to the steering column assembly and including a plurality of stator winding nodes supported on a first axial surface of the stator assembly in a circular pattern;
a ferrous rotor interconnected to the steering shaft and in operational engagement with the stator assembly, wherein rotational motion of the rotor is transferred to the steering shaft.

13. The steer by wire system of claim 12, wherein each one of the plurality of stator winding nodes includes:
a core defining an upper channel and a lower channel;
a rare earth magnet positioned within the upper channel and a rare earth magnet positioned within the lower channel;
a gap adjacent each side of the rare earth magnet positioned within the upper channel and a gap adjacent each side of the rare earth magnet positioned within the lower channel; and
a copper winding wrapped around the core and the rare earth magnets, the copper winding including a first end and a second end;
wherein, the plurality of stator winding nodes are connected to one another in series, via the first and second ends of the copper windings, around the stator assembly.

14. The steer by wire system of claim 13, wherein:
the stator assembly includes a plurality of fir-tree columns extending axially from the first axial surface of the stator assembly, one fir-tree column positioned between each adjacent pair of the plurality of stator winding nodes, the fir-tree columns adapted to support the plurality of stator winding nodes on the stator assembly;
the core of each of the plurality of stator winding nodes includes a first side having an axial notch and a second side having an axial notch;
each of the plurality of fir-tree columns includes an axial ridge extending along a first side and an axial ridge extending along a second side;
wherein, for each one of the plurality of stator winding nodes:
the first side of the core is positioned in contact with the second side of a one of the plurality of fir-tree columns that is adjacent the first side of the core, and the axial ridge of the second side of the one of the plurality of fir-tree columns that is adjacent the first side of the core engages the axial notch of the first side of the core; and
the second side of the core is positioned in contact with the first side of a one of the plurality of fir-tree columns that is adjacent the second side of the core, and the axial ridge of the first side of the one of the plurality of fir-tree columns that is adjacent the second side of the core engages the axial notch of the second side of the core.

15. The steer by wire system of claim 14, wherein:
the core of each of the plurality of stator winding nodes includes:
a first retaining finger adjacent the first side and extending axially through a hole formed within the stator assembly; and
a second retaining finger adjacent the second side and extending axially through a hole formed within the stator assembly;
the steering column assembly including a plurality of retaining clips, each retaining clip adapted to secure a distal end of the first retaining finger of one of the plurality of stator winding nodes to a distal end of the second retaining finger of an adjacent one of the plurality of stator winding nodes adjacent a second axial surface of the stator assembly and prevent any of the plurality of stator winding nodes from being removed from the first surface of the stator assembly.

16. The steer by wire system of claim 15, wherein, for each of the plurality of stator winding nodes:
the first retaining finger includes a channel adapted to partially surround the first end of the copper winding, wherein the first end of the copper winding extends through the hole in the stator assembly along with the first retaining finger; and
the second retaining finger includes a channel adapted to partially surround the second end of the copper winding, wherein the second end of the copper winding extends through the hole in the stator assembly along with the second retaining finger.

17. The steer by wire system of claim 16, wherein the stator assembly and the steering shaft are supported relative to one another by a roller bearing adapted to allow the steering shaft to rotate relative to the stator assembly, the steer by wire system further including a magnetorheological brake adapted to selectively provide resistance to rotational movement of the steering shaft.

18. The steer by wire system of claim 17, wherein the magnetorheological brake includes:
an outer shell fixedly mounted onto a radially inner surface of the stator assembly;
an electromagnetic coil extending around the outer shell between the outer shell and the stator assembly;
a drum fixedly mounted onto the steering shaft and rotatable with the steering shaft;
a pair or roller bearings adapted to support the outer shell and the drum relative to one another and allow rotational movement of the drum within the outer shell; and
a magnetorheological fluid positioned within a chamber defined by the outer shell and the drum, wherein selective activation of the electromagnetic coil creates an electromagnetic field within the chamber and changes viscosity of the magnetorheological fluid therein.

19. The steer by wire system of claim 16, wherein the stator assembly and the rotor are supported relative to one another by a roller bearing adapted to allow the rotor to rotate relative to the stator assembly, the steer by wire system further including a planetary gearset positioned between and interconnecting the rotor to the steering shaft and adapted to increase the torque transferred from the rotor to the steering shaft.

20. A vehicle having a steer by wire steering system, the steer by wire system comprising:
a controller;
a road wheel actuator in communication with the controller and adapted to control steerable wheels of the vehicle; and
a steering column assembly, the steering column assembly including:
a steering shaft rotationally supported within the steering column assembly and adapted to support a steering wheel at a distal end thereof; and
a homopolar direct drive unit adapted to selectively apply rotational torque to the steering shaft, the homopolar direct drive unit including:
a non-ferrous stator assembly fixedly mounted to the steering column assembly and including:
a plurality of stator winding nodes supported on a first axial surface of the stator assembly in a circular pattern, each one of the plurality of stator winding nodes including:
a core defining an upper channel and a lower channel;
a rare earth magnet positioned within the upper channel and a rare earth magnet positioned within the lower channel;
a gap adjacent each side of the rare earth magnet positioned within the upper channel and a gap adjacent each side of the rare earth magnet positioned within the lower channel; and
a copper winding wrapped around the core and the rare earth magnets, the copper winding including a first end and a second end, wherein, the plurality of stator winding nodes are connected to one another in series, via the first and second ends of the copper windings, around the stator assembly; and
a plurality of fir-tree columns extending axially from the first axial surface of the stator assembly, one fir-tree column positioned between each adjacent pair of the plurality of stator winding nodes, the fir-tree columns adapted to support the plurality of stator winding nodes on the stator assembly; and
a ferrous rotor interconnected to the steering shaft and in operational engagement with the stator assembly, wherein rotational motion of the rotor is transferred to the steering shaft; and, one of:
a magnetorheological brake adapted to selectively provide resistance to rotational movement of the steering shaft and including:
an outer shell fixedly mounted onto a radially inner surface of the stator assembly;
an electromagnetic coil extending around the outer shell between the outer shell and the stator assembly;
a drum fixedly mounted onto the steering shaft and rotatable with the steering shaft;
a pair or roller bearings adapted to support the outer shell and the drum relative to one another and allow rotational movement of the drum within the outer shell; and
a magnetorheological fluid positioned within a chamber defined by the outer shell and the drum, wherein selective activation of the electromagnetic coil creates an electromagnetic field to the chamber and changes viscosity of the magnetorheological fluid therein; or
a planetary gearset positioned between and interconnecting the rotor to the steering shaft and adapted to increase the torque transferred from the rotor to the steering shaft.
